(19) United States
(12) Patent Application Publication
(10) Pub. No.: US 2026/0187289 A1
(43) Pub. Date: Jul. 2, 2026

(54) CHIP SECURITY MODULE AND SECURITY ENCRYPTION METHOD

(71) Applicant: Nanjing Silergy Micro Technology Co., Ltd., Nanjing (CN)

(72) Inventors: Yu Liu, Nanjing (CN); Lei Zhang, Nanjing (CN); Rongxin Liu, Nanjing (CN)

(21) Appl. No.: 19/433,216

(22) Filed: Dec. 26, 2025

(30) Foreign Application Priority Data
Dec. 31, 2024 (CN) 202411999288.8

(51) Int. Cl. G06F 21/72; G06F 21/55

(52) U.S. Cl. CPC G06F 21/72; G06F 21/552; G06F 2221/033

(57) ABSTRACT

A chip security module can include: an encryption unit configured to execute an encryption operation instruction, monitor execution process of the encryption operation instruction, and determine whether the execution process of the encryption operation instruction matches a corresponding security sequence; where in response to determining that the execution process of the encryption operation instruction matches the corresponding security sequence, the chip security module controls an execution result being outputted based on the encryption operation instruction; where in response to determining that the execution process of the encryption operation instruction does not match the corresponding security sequence, a corresponding action is taken according to application requirements; and where the security sequence is used for characterizing a preset execution process of the corresponding encryption operation instruction.

### RELATED APPLICATIONS

This application claims the benefit of Chinese Patent Application No. 202411999288.8, filed on Dec. 31, 2024, which is incorporated herein by reference in its entirety.

### FIELD OF THE INVENTION

The present invention generally relates to the field of computer technology, and more particularly to chip encryption modules and security encryption methods.

### BACKGROUND

With the development of computer technology, most system-on-chips (SoCs) are equipped with encryption units, such as identity authentication. In existing technologies, security modules are typically implemented through a combination of software and hardware, and encryption can be achieved by integrating software with the digital system modules of the chip to improve the flexibility of applications. However, there are some vulnerabilities in the existing technologies, possibly resulting in poor security of the security modules. For example, if the software is exposed to third parties through operations such as disassembly, it may lead to the leakage of private keys. Moreover, in existing technologies, the security of security modules may be ensured by way of hardwired physical circuits in the chip or firmware state machine of in ROM (Read-Only Memory), which can result in relatively single functions. When there are different requirements, it may be necessary to redesign the layout of the chip or adopt a dual-core design in the chip, which can lead to higher costs.

### BRIEF DESCRIPTION OF THE DRAWINGS

FIG. 1 is a schematic block diagram of a first example chip security module, in accordance with embodiments of the present invention.

FIG. 2 is a schematic block diagram of a second example chip security module, in accordance with embodiments of the present invention.

FIG. 3 is a schematic block diagram of an example generation process of a group of security sequences, in accordance with embodiments of the present invention.

FIG. 4 is a schematic block diagram of an example encryption unit, in accordance with embodiments of the present invention.

FIG. 5 is a flow diagram of an example monitoring process of a hardware monitor, in accordance with embodiments of the present invention.

FIG. 6 is a flow diagram of an example security encryption method, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

With the continuous development of chip technology, security chips and SOC chips are generally provided with encryption units, such as identity authentication unit. Most chips adopt a combination of software and hardware to build security modules. While this approach improves the flexibility of applications, it can also bring security risks because the software lacks security measures. In view of this, particular embodiments provide a chip security module and security encryption method. Without reducing flexibility advantages brought by the combination of software and hardware, the ability to reduce software exposure risks can be improved, the security of the chip improved, and the cost of chip design also reduced. Particular embodiments may be described by taking data encryption operations as an example; however, certain embodiments can also be used in data decryption, digital signature, signature verification, and the like.

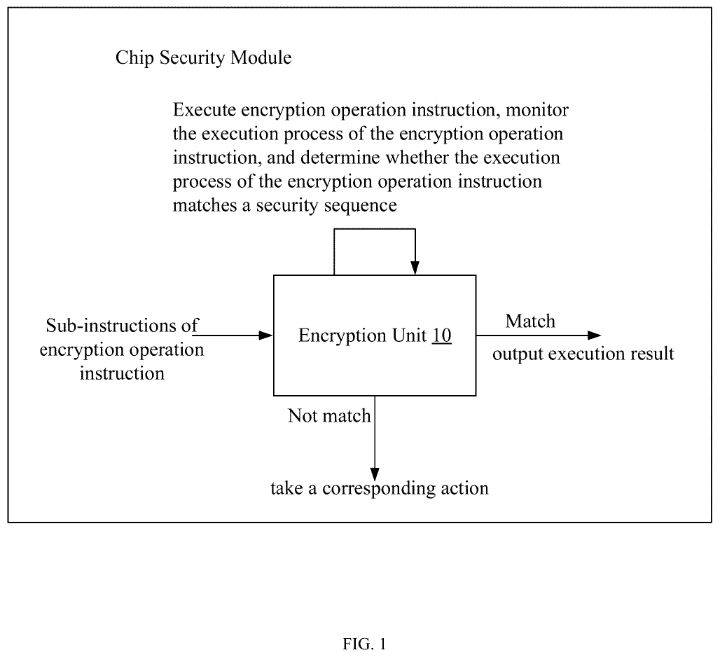

Referring now to FIG. 1, shown is a schematic block diagram of a first example chip security module, in accordance with embodiments of the present invention. In this particular example, the chip security module can include encryption unit 10. Encryption unit 10 may receive and execute an encryption operation instruction, monitor the execution process of the encryption operation instruction, and determine whether the execution process of the encryption operation instruction matches a corresponding security sequence. In response to determining that the execution process of the encryption operation instruction matches the corresponding security sequence, the chip security module can control that an execution result is outputted based on the encryption operation instruction. In response to determining that the execution process of the encryption operation instruction does not match the corresponding security sequence, the chip security module or another module other than the chip security module can take a corresponding action according to application requirements. The security sequence can characterize a preset execution process of the corresponding encryption operation instruction. In one example, the security sequence can be stored in a memory of the chip security module, and encryption unit 10 may read the security sequence from the memory. In another example, the security sequence can be arranged in encryption unit 10, but any suitable storing position of the security sequence can be utilized in certain embodiments.

In particular embodiments, encryption unit 10 may receive a plurality of sub-instructions extracted from the encryption operation instruction, execute the plurality of sub-instructions, monitor the execution sequence of the plurality of sub-instructions, and determine whether the execution sequence matches the corresponding security sequence. Any suitable approach whereby the encryption operation instruction is executed by obtaining a plurality of sub-instructions according to the encryption operation instruction can be utilized in certain embodiments. For example, the encryption operation instruction can be f=x+y−z, and the encryption unit may receive sub-instructions split from the encryption operation instruction. In another example, the encryption operation instruction can be verification of digital signature, and the encryption unit may receive sub-instructions that need to be executed when executing the encryption operation instruction.

The security sequence can be determined according to at least two of the sub-instructions. In one example, the security sequence may be determined according to all the sub-instructions, and a number of the sub-instructions can be equal to a number of sequences in the security sequence. In this particular example, the execution sequences of the sub-instructions can be in one-to-one correspondence with the sequences in the security sequence. In another example, the security sequence may be determined according to a part of the sub-instructions, and the number of the sequences in the security sequence can be less than the number of sub-instructions. In this example, N sub-instructions in the plurality of sub-instructions may be in one-to-one correspondence with the sequences in the security sequence, where N is greater than or equal to 2.

For example, 5 sub-instructions can be extracted from the encryption operation instruction, the security sequence can include 3 sequences, so 3 sub-instructions (e.g., the first sub-instruction, the second sub-instruction, and the third sub-instruction) in the 5 sub-instructions can be in one-to-one correspondence with the 3 sequences in the security sequence. In one example, the sub-instructions that are received and executed by encryption unit 10 can be tag commands. Alternatively, each sub-instruction can be one tag command, and the security sequence may be determined according to at least two of the tag commands. Each tag command can include at least one of: an input parameter address, an output parameter address, and a base instruction for achieving the encryption operation instruction.

In the below examples, the tag command can include the input parameter address, the output parameter address, and the base instruction. Each sub-instruction can be set as a tag command, and the tag command may be transmitted in the communication process. In this way, even if a third party acquires the tag command in the communication process, the third party cannot acquire the specific sub-instruction. The situation can be prevented whereby an intermediate variable and results of the previous process and subsequent process are acquired by a unit rather than the encryption unit and the private key is derived accordingly. Therefore, the security of the chip security module may be improved. In the following example, the sub-instruction can be the tag command.

The security sequence can be determined according to the sub-instructions extracted from the corresponding encryption operation instruction. Alternatively, the sub-instruction can be the tag command. In one example, the security sequence can be determined according to the tag commands extracted from the corresponding encryption operation instruction. The encryption operation instruction (e.g., the encryption algorithm or verification of digital signature) can be split to at least two base instructions. In particular embodiments, the base instructions, the input parameter addresses and the output parameter addresses of these base instructions may be combined to generate at least two tag commands, and then the at least two tag commands can be combined to generate the security sequence. In one example, the encryption operation instruction can be split to multiple base instructions, all the multiple base instructions may be used to generate corresponding tag commands, and all the tag commands can be combined to generate the security sequence.

In another example, the encryption operation instruction may be split to multiple base instructions, some base instructions (e.g., main base instructions) of the multiple base instructions can be used to generate corresponding tag commands, and these tag commands may be combined to generate the security sequence. In this way, the security sequencer of particular embodiments can characterize a preset execution process of the corresponding encryption operation instruction. Therefore, whether the current execution process is the correct encryption operation sequence may be determined by comparing the execution process of the current encryption operation instruction and the preset execution process indicated by the security sequence, and thus, the security of the chip may be ensured. In one example, the security sequence can be stored in the encryption unit or a memory in the chip security module. In another example, the security sequence may be stored in a module in the chip security module other than the encryption unit and the memory. The security sequence may only be readable to the chip security module. Once the security sequence is protected and locked up, the security sequence may not be changed. In some examples, the security sequence can be written into the chip security module in the chip configuration phase. Different application requirements may be satisfied by writing different security sequences. Therefore, satisfying different requirements by changing metal layout of the chip can substantially be avoided, time cost reduced, and manufacturing cost also reduced. In some examples, after the chip is in mass production, the security sequence may not be changed, thus ensuring the security of the chip.

When the execution process of the encryption operation instruction does not match the corresponding security sequence, a corresponding action can be taken according to application requirements. For example, the corresponding action can include one of or a combination of two or more of: the chip security module controlling that not outputting the execution result based on the current encryption operation instruction, the chip security module or another module other than the chip security module erasing the secret key and/or the private key stored in the chip security module, destroying a memory in the chip security module, halting the chip, and restarting the chip, which can ensure security of the chip and data.

When the execution process of the encryption operation instruction matches the security sequence, the chip security module can control that an execution result is outputted based on the encryption operation instruction. The execution result can include the computing result and/or the computing state of the encryption operation instruction. The computing state can characterize whether the encryption operation instruction has been successfully executed or whether the encryption computing of the encryption operation instruction is successful. If the current encryption operation fails, the encryption operation can be executed again, or information may be fed back to a main controller, and then the chip security module can operate based on the instruction of the main controller.

In particular embodiments, the security sequence corresponding to encryption operation instruction required by application requirements can be configured in advance. The execution process of the current encryption operation instruction may be monitored when the encryption operation instruction is being executed. When the execution process does not match the preconfigured security sequence, a corresponding action can be taken to ensure chip security and avoid crack, thereby ensuring data security. In particular embodiments, chip security monitoring may be achieved by software configuration. Different security sequences can be configured in advance for different application requirements. Therefore, the hardware cost for ensuring chip security can accordingly be reduced.

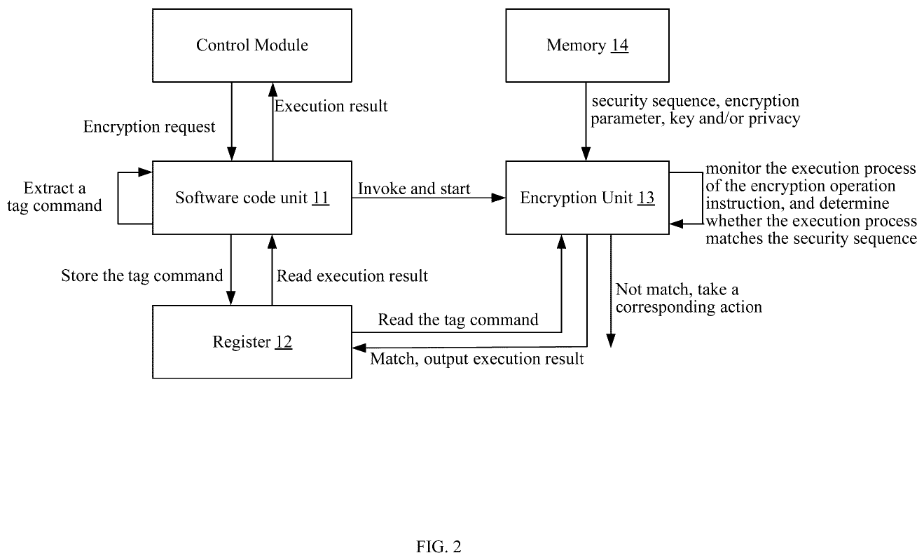

Referring now to FIG. 2, shown is a schematic block diagram of a second example chip security module, in accordance with embodiments of the present invention. In this particular example, the chip security module can include encryption unit 13 and memory 14. Memory 14 can store at least one group of security sequences. In some examples, memory 14 can also store the secret key and/or the private key. Further, memory 14 may be a protected and independent storage unit. For example, memory 14 is a Flash type of memory. With memory 14, the security sequence, and the secret key and/or the private key can be protected and prevented from being leaked, thereby ensuring data security. In some examples, memory 14 may further store other parameters for encryption. For example, the parameters may be determined according to the encryption algorithm used by different application requirements.

In addition, the chip security module can also include software code unit 11 and register 12. Software code unit 11 and encryption unit 13 may both connect to register 12, and can be capable of performing read and write operations. In some examples, software code unit 11 can connect to encryption unit 13, and when software code unit 11 receives an encryption request, software code unit 11 may invoke and begin encryption unit 13. Encryption unit 13 can also connect to memory 14. To perform the encryption operation, encryption unit 13 may read, from memory 14, the security sequence, the secret key and/or the private key, and parameters for encryption.

In particular embodiments, the chip security module can control software code unit 11 to communicate with the main controller, and can control encryption unit 13 to strictly control the output. Therefore, the security sequence, the secret key and/or the private key, and parameters for encryption cannot be obtained through a connection to an external device, and chip security and data security can be further ensured. In some embodiments, the main controller is a central processing unit (CPU) of the chip, or the main controller is another processing unit or device. For example, encryption unit 13 can autonomously start to execute the encryption operation instruction by monitoring the state of register 12. In this example, encryption unit 13 may not need to be in communication connection with software code unit 11 and may not communicate with software code unit 11.

When it needs to perform encryption process on data, the main controller can send an encryption request to software code unit 11, and the encryption request can include an input parameter and the encryption operation instruction. In particular embodiments, the input parameter can be data to be encrypted. In another example, encryption operation instructions for various types of data to be encrypted can be configured in software code unit 11 in advance, the encryption request can include the data to be encrypted and not the encryption operation instruction. In this case, software code unit 11 may acquire the encryption operation instruction according to the type of data to be encrypted in the encryption request.

In addition, software code unit 11 can extract at least two tag commands from the encryption operation instruction, and may transmit the at least two tag commands to encryption unit 13 through register 12. Encryption unit 13 can execute an encryption operation according to the at least two tag commands. Further, software code unit 11 can acquire the encryption operation instruction according to the encryption request, and acquire at least two tag commands from the encryption operation instruction. Software code unit 11 can compile the encryption operation instruction to obtain at least two corresponding base instructions and input and output parameters corresponding to the at least two corresponding base instructions, and may generate at least two tag commands including the base instructions, input parameter addresses and output parameter addresses.

In particular embodiments, the tag command can include an identifier part ID and a data part Data. The identifier part ID can store a base instruction corresponding to a step compiled from the encryption operation instruction, and the data part Data can store corresponding input parameter address and/or output parameter address. The input parameter address and the output parameter address can be used for indicating the address where the input parameter is stored and the address where the output parameter is stored. The output parameter can include an intermediate output parameter and an output result. The intermediate output parameter can characterize an output result of a non-last tag command. The output result can be used for characterizing the output result of the last tag command, that is, the output result of the encryption operation instruction.

In one example, register 12 may only transmit the tag command to encryption unit 13. In another example, register 12 can transmit the tag command to encryption unit 13, and store or cache the output result and parameters of the encryption operation instruction. The stored or cached parameters of the encryption operation instruction may include parameters included by the encryption operation instruction itself (e.g., the stored or cached parameters do not include the intermediate output result of the base instruction, the base instruction is obtained by compiling the encryption operation instruction). For example, the stored or cached parameters of the encryption operation instruction can include the input parameter.

In addition, if register 12 may only transmit the tag command to encryption unit 13, the chip security module of particular embodiments can also include a parameter register for storing or caching the output result and the parameter of the encryption operation instruction, which facilitates data transmission. In addition, software code unit 11 can write the acquired tag commands of the encryption operation instruction into register 12. After encryption unit 13 is invoked and started by software code unit 11, or after encryption unit 13 is automatically started when finding that the states of register 12 change, encryption unit 13 may read the tag commands of the encryption operation instruction from register 12.

In one embodiment, encryption unit 13 can execute the encryption operation instruction, and may monitor the execution process. After encryption unit 13 is started, encryption unit 13 may read the corresponding tag command from register 12, and acquire, from memory 14, the security sequence corresponding to the encryption operation instruction, parameters, secret key and/or private key for encryption operation. Based on the acquired parameters, secret key and/or private key, encryption unit 13 can execute the tag commands successively (e.g., executes the sub-instructions of the encryption operation instruction).

Encryption unit 13 can also monitor the execution process of the encryption operation instruction, and acquire the sequence of tag commands that have been executed, and determine whether the tag command sequence matches the corresponding security sequence to determine whether the execution process of the encryption operation instruction matches the corresponding security sequence. If the execution process of the encryption operation instruction matches the corresponding security sequence, the chip security module can control that an execution result is outputted based on the encryption operation instruction. That is, the chip security module can control the current encryption operation to output the execution result. The outputted execution result may be transmitted to the main controller through register 12 or the parameter register.

After encryption unit 13 executes the encryption operation instruction, encryption unit 13 can write the execution result into register 12 or the parameter register. Software code unit 11 may read, from register 12 or the parameter register, the execution result of the encryption output and transmit the execution result to the main controller. In another example, the main controller may directly read, from register 12 or the parameter register, the execution result of the encryption request. Any suitable method of the main controller acquiring the execution result can be supported in certain embodiments. The execution result can include the computing result and/or the computing state of execution of the current encryption operation instruction.

The computing state can be used for characterizing whether the encryption operation instruction has been successfully executed or whether the encryption computing of the encryption operation instruction is successful. If the execution process of the encryption operation instruction does not match the corresponding security sequence, an action may be taken according to practical application requirements. In one embodiment, when the execution process of the encryption operation instruction matches the security sequence, this can indicate that the tag commands in the security sequence are all in the executed tag command sequence, and the sequence of the tag commands in the security sequence is same as the sequence of the tag commands in the executed tag command sequence. In some embodiments, the security sequence may be determined in advance according to the tag commands extracted from the corresponding encryption operation instruction, and stored in memory 14. For example, the security sequence can include a sequence header Group Header, a data part Data, and an ending indicator End.

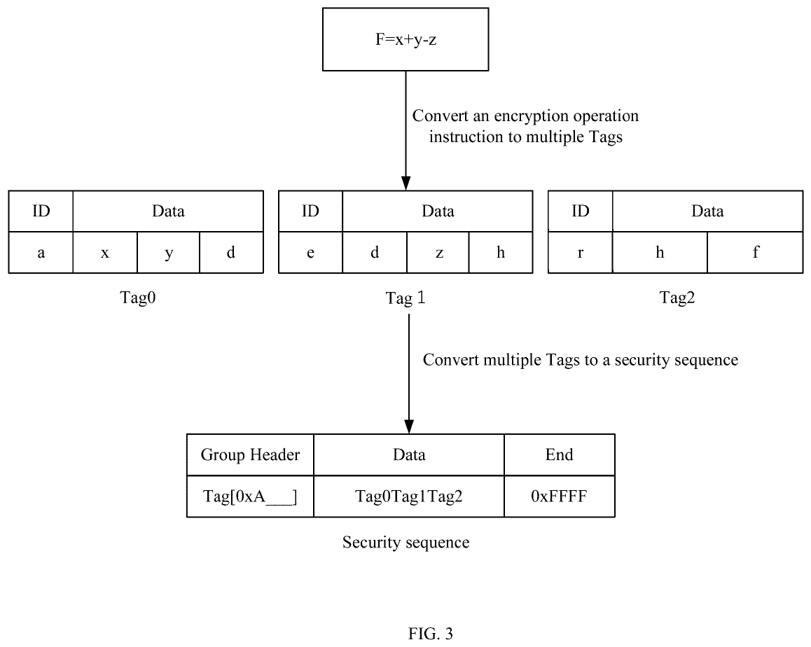

Referring now to FIG. 3, shown is a schematic block diagram of an example generation process of a group of security sequences, in accordance with embodiments of the present invention. In this particular example, the encryption operation instruction can be f=x+y−z. In particular embodiments, the encryption operation instruction can be divided into multiple tag commands Tag. For example, the encryption operation instruction f=x+y−z may be divided into 3 tag instructions: Tag0(a, x, y, d), Tag1(e, d, z, h), Tag2(r, h, f). Next, Tag0, Tag1, and Tag2 can be sequenced and combined as the data part of the security sequence. Tag0 may denote operation d=x+y, a may denote an add instruction, x and y are addresses of two input parameters of the add instruction, and d may denote the address for storing the intermediate output parameter of the operation x+y.

Tag1 may denote operation h=d−z, e may denote a subtraction instruction, d and z can be addresses of two input parameters of the subtraction instruction, and h may denote the address for storing the intermediate output parameter of the operation d-z. Tag2 may denote operation of reading data stored in the address h and storing the data into an address f in the register, r may denote a read instruction, and f can be the register address. Next, the security sequence can be generated based on Tag0(a, x, y, d), Tag1(e, d, z, h), Tag2(r, h, f). As shown in FIG. 3, the security sequence can include a sequence header (Tag[0xA_]), the sequence data part (Tag0Tag1Tag2), and an ending indicator (0xFFFF). The sequence header can identify the encryption operation instruction corresponding to the security sequence, and the sequence data part can be formed by the tag commands extracted from the encryption operation instruction.

In some embodiments, after generating the security sequence based on the above method, the security sequence, the secret key and/or the private key, and the parameters for encryption can all be stored in memory 14 for achieving the subsequent encryption operation and security monitoring. Any suitable format of the tag command and the storage format of the security sequence as long as they can achieve monitoring and comparing can be supported in certain embodiments. In one example, memory 14 is a non-volatile memory, such as a Flash memory, or memory 14 is a one-time programmable memory such as eFuse; however, any suitable type of memory can be employed in certain embodiments. After the security sequence, the secret key and/or the private key, and the parameters for encryption can be stored in memory 14, memory 14 may enter a protected and locked state, any rewriting operation may not be allowed, and memory 14 can be readable only to encryption unit 13, thereby ensuring security of chip and data.

In certain applications, the chip may perform various tasks, and these tasks can involve different encryption operation instructions. Therefore, in particular embodiments, the sequence headers can be arranged to be in one-to-one correspondence with the encryption operation instructions, and the sequence headers are configured to identify different security sequences for different encryption operation instructions. In one embodiment, the chip may have fewer function, the chip security module can execute only one type of encryption operation instruction, and memory 14 may store only one security sequence. In such case, the sequence header and the ending indicator may be omitted, and the security sequence can include only the data part, thereby saving storage space and improving loading efficiency.

In particular embodiments, the chip security module can access the sequence headers of the security sequences according to the current encryption operation instruction, and may acquire the security sequence corresponding to the current encryption operation instruction. In some embodiments, encryption unit 13 can monitor the execution process of the encryption operation instruction. That is, when the tag commands of the encryption operation instruction are executed, encryption unit 13 can acquire the executed tag command sequence, encryption unit 13 can access the sequence headers of the security sequences in memory 14 based on the encryption operation instruction corresponding to the executed tag command sequence to acquire the security sequence corresponding to the current encryption operation instruction, and can compare the executed tag command sequence against the security sequence. In another example, another security monitoring module may be provided, the security monitoring module can acquire the executed tag command sequence from encryption unit 13, may access the sequence headers of the security sequences in memory 14 based on the current encryption operation instruction to acquire the security sequence corresponding to the current encryption operation instruction, and can compare the executed tag command sequence against the security sequence.

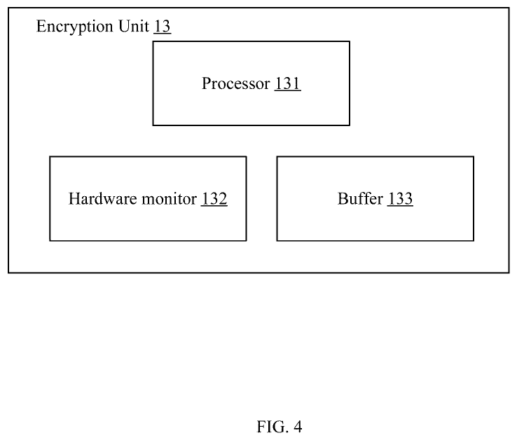

Referring now to FIG. 4, shown is a schematic block diagram of an example encryption unit, in accordance with embodiments of the present invention. In this particular example, encryption unit 13 can monitor the encryption process of the encryption operation instruction, and encryption unit 13 can include processor 131, hardware monitor 132, and buffer 133. Processor 131 can acquire at least two tag commands from register 12, sequentially execute the at least two tag commands, and selectively store output parameters of the at least two tag commands into buffer 133. For example, processor 131 can store the output parameters of the non-last tag commands (e.g., the at least two tag commands excluding the last tag command) into buffer 133.

The output parameters of which tag commands are stored in buffer 133 may be determined according to certain application requirements. Processor 131 can read the tag command from register 12. Processor 131 can acquire the input parameter according to the input parameter address in the tag command. Processor 131 can read from memory 14 the security sequence, the secret key and/or the private key, and the parameters for encryption. Processor 131 may obtain output parameters by performing computation on the input parameters based on the secret key and/or the private key, the parameters for encryption, and the base instruction in the tag command. Processor 131 can store the output parameters to the position indicated by the output parameter address. For different tag commands, the output parameter may be the intermediate output parameter or the output result. The intermediate output parameter can be the output result of the non-last tag command, and the output result is the output result of the last tag command. For example, the intermediate output parameter address may be stored in buffer 133.

In some embodiments, buffer 133 is a buffer region or other storage region capable of satisfying requirements. Buffer 133 may have access restrictions and may be accessible only within encryption unit 13. In this way, it may be prevented whereby intermediate variables and various results are acquired by an external device or the third-party and the secret key and/or the private key is decrypted. As a result, data security can be improved. In the execution process of processor 131, hardware monitor 132 can continuously monitor the operation state of register 12 and/or processor 131, in order to prevent software code unit 11 from being invaded.

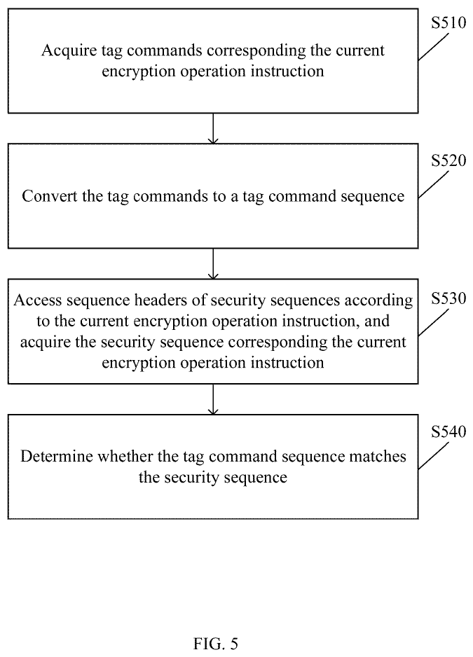

Referring now to FIG. 5, shown is a flow diagram of an example monitoring process of a hardware monitor (e.g., 132), in accordance with embodiments of the present invention. In this particular example, the monitoring process can include the following operations for steps. In S510, the tag commands corresponding to the currently executed encryption operation instruction can be acquired. The tag commands may be acquired by monitoring the operation state of register 12 and/or processor 131. In some examples, the tag commands can be acquired by only monitoring the operation state of register 12, or only monitoring the operation state of processor 131. In some embodiments, the tag commands can be acquired by monitoring the operation state of both register 12 and processor 131, in order to ensure the reliability of the monitored data.

In S520, the tag commands can be converted into a tag command sequence. The process of forming the tag command sequence may be analogous to the process of forming the data part of the security sequence. In S530, the sequence headers of the security sequences can be accessed according to the currently executed encryption operation instruction, in order to acquire the security sequence corresponding to the currently executed encryption operation instruction.

In S540, whether the tag command sequence matches the security sequence can be determined. Since the data part of the security sequence is formed by the tag commands extracted from the corresponding encryption operation instruction, the data part of the security sequence may be the tag command sequence in the ideal condition. In one embodiment, encryption unit 13 may asynchronously execute the encryption operation instruction and monitoring. That is, encryption unit 13 can determine the tag command sequence in real time in the execution process of the encryption operation instruction, and sequentially compare the tag commands in the tag command sequence against the security sequence.

When the tag command sequence does not match the security sequence, encryption unit 13 may stop the execution of the encryption operation instruction or other actions. In another example, encryption unit 13 can acquire the complete tag command sequence corresponding to the executed encryption operation instruction after the execution of the encryption operation instruction is completed, and may determine whether the tag command sequence matches the security sequence. Any suitable compare method or approach can be supported in certain embodiments.

In particular embodiments, S530 and S540 may be executed by the hardware monitor, or can be executed by another unit, such as an additional digital hardware unit. In some embodiments, the security sequence can be formed by important ones (e.g., the main base instructions in the encryption operation instruction) of all tag commands extracted from the encryption operation instruction. In this case, the security sequence may include a part of the tag command sequence, and hardware monitor 132 may set a different matching rule for this security sequence to satisfy different requirements. For example, the matching rule can be whether the security sequence matches at least a part of the tag command sequence.

If the tag command sequence does not match the security sequence, this may indicate that the software code unit has been exposed to an invader. The invader may want to calculate the secret key and/or the private key according to the output result of the encryption operation. In this case, the chip may need to take a corresponding action according to practical application requirements, in order to protect the output result and ensure data security. In particular embodiments, the action taken in response to hardware monitor 132 finding that the tag command sequence and the security sequence do not match can include: not outputting the execution result based on the current encryption operation, erasing the secret key and/or the private key stored in the chip security module, destroying or otherwise disabling memory 14, halting the chip, and/or restarting the chip. In certain applications, one or more of the above actions may be adopted and applied in the chip according to the security level and the important level of the chip. Alternatively, action(s) other than the above action may be adopted and applied in the chip according to certain conditions.

If hardware monitor 132 monitors that the tag command sequence matches the security sequence, the execution result can be outputted, and software code unit 11 may read the execution result and feed back the execution result. The execution result can include a computing result and/or computing state. The computing state may indicate whether the present computing is successful or whether the present computing has been successfully executed. In some embodiments, to feed back the encryption result, encryption unit 13 can write the output result into register 12 in the form of tag command, or encryption unit 13 may directly write the output result into the parameter register. In one embodiment, if the encryption operation fails, software code unit 11 may re-execute the encryption operation, or software code unit 11 may feed back information to the main controller and operate according to the instruction of the main controller.

In particular embodiments, the execution process of the encryption operation instruction can be monitored, and whether the execution process matches the corresponding security sequence may be determined. If it is determined that the execution process of the current encryption operation instruction matches the corresponding security sequence, the execution result can be outputted based on the current encryption operation instruction. If it is determined that the execution process of the current encryption operation instruction does not match the corresponding security sequence, a corresponding action may be taken according to practical application requirements. The security sequence can be used for characterizing a preset execution process of the corresponding encryption operation instruction. In this way, particular embodiments may improve chip security. Since the monitoring is in the software level, different security sequences can be configured for different application requirements, and the design cost of the chip accordingly reduced.

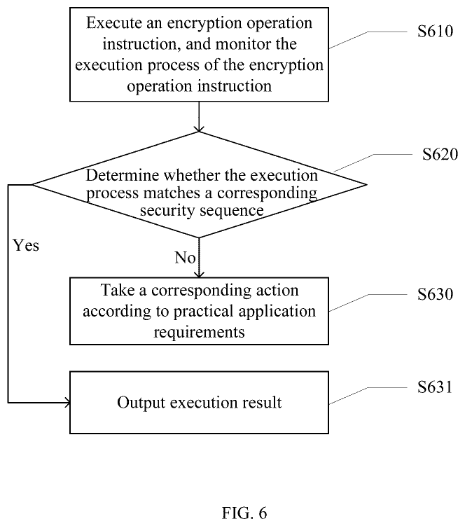

Referring now to FIG. 6, shown is a flow diagram of an example security encryption method, in accordance with embodiments of the present invention. In this particular example, the security encryption method can include the following steps. In S610, the encryption operation instruction can be executed, and the execution process of the encryption operation instruction monitored. In S620, whether the execution process matches the corresponding security sequence may be determined. The security sequence can be used for characterizing a preset execution process of the corresponding encryption operation instruction.

In response to determining that the execution process does not match the security sequence, S630 may be executed. In response to determining that the execution process matches the security sequences, S631 can be executed. In S630, an action corresponding to practical application requirements can be taken. In S631, the execution result may be outputted based on the current encryption operation instruction. In one embodiment, 610 can include: a plurality of sub-instructions extracted from the encryption operation instruction can be received, the plurality of sub-instructions executed, and the execution sequence of the plurality of sub-instructions monitored.

In one embodiment, the number of the plurality of sub-instructions can be equal to the number of the sequences in the security sequence, and the execution sequence of the plurality of sub-instructions may be in one-to-one correspondence with the sequences in the security sequence. In another example, the security sequence can be according to at least two of the plurality of sub-instructions, and the number of the plurality of sub-instructions may be greater than the number of the sequences in the security sequence. In one embodiment, each sub-instruction can be a tag command, e.g., each sub-instruction is configured as one tag command. The tag command can include at least one of an input parameter address, an output parameter address, and a base instruction for executing the encryption operation instruction.

The security sequence may be determined according to the sub-instructions extracted from the corresponding encryption operation instruction. For example, the sub-instruction can be configured in form of the tag command. In one embodiment, the security sequence may be determined according to the tag commands extracted from the corresponding encryption operation instruction. The tag commands can include at least one of an input parameter address, an output parameter address, and a base instruction for executing the encryption operation instruction. The input parameter address may denote the storage position of the input parameter, and the output parameter address may denote the storage position of the output parameter. The tag command may not include specific value of the parameter. The output parameter address can include an intermediate output parameter address and an output result address. The intermediate output parameter address and the output result address can be directed to different storage units. The intermediate output parameter address may indicate where the output result of the non-last tag command is stored. External devices may not read and write the storage unit corresponding to the intermediate output parameter address. The output result address can indicate where the output result of the last tag command is stored, and the output result of the last tag command may be the output result of the encryption operation instruction.

The encryption operation instruction (e.g., encryption algorithm) can be split into at least two base instructions. In particular embodiments, each base instruction and its corresponding input and output parameters can be combined to generate the tag command, and at least two tag commands are combined to generate the security sequence. In one embodiment, all the base instructions split from the encryption operation instruction are converted into corresponding tag commands, and all the tag commands can be combined to generate the security sequence. In another example, some base instructions (e.g., main base instructions in the encryption operation instruction) of the base instructions split from the encryption operation instruction can be converted into corresponding tag commands, and these tag commands may be combined to generate the security sequence. In view of the above, the security sequence in particular embodiments can characterize a preset execution process of the corresponding encryption operation instruction. By comparing the execution process of the current encryption operation instruction against the preset execution process indicated by the security sequence to determine whether the current execution process is the correct encryption operation sequence, the chip security can be ensured.

In one embodiment, the execution of the encryption operation instruction can include: receiving an encryption request, and executing an encryption operation instruction corresponding to the encryption request in response to the received encryption request. In one example, the security sequence can include a sequence header, a sequence data part, and an ending indicator. The sequence header can be used for identifying the encryption operation instruction corresponding to the security sequence. The sequence data part may be formed by tag commands extracted from the corresponding encryption operation instruction, and can characterize a preset execution process of the tag commands (e.g., the preset execution process of the corresponding encryption operation instruction).

In one embodiment, the determination of whether the execution process matches the corresponding security sequence can also include: acquiring a tag command sequence corresponding to the encryption operation instruction, accessing the sequence heads of the security sequences, and finding the security sequence corresponding to the current encryption operation instruction according to the current encryption operation instruction. Acquiring at least two tag commands corresponding to the current encryption operation instruction can include generating the tag command sequence, and determining whether the tag command sequence matches the corresponding security sequence.

In one embodiment, at least one of the security sequences, the secret key and/or the private key, and the parameter for encryption can be independently stored in a memory. The action which is taken when the execution process does not match the corresponding security sequence can include one or more of: not outputting the execution result based on the encryption operation instruction, erasing the secret key and/or the private key stored in the chip security module, destroying a memory in the chip security module, halting a chip, and restarting the chip.

In one embodiment, when the execution process matches the corresponding security sequence, an execution result can be outputted based on the encryption operation instruction. The execution result can include a computing result and/or a computing state of the execution of the present encryption operation instruction. The computing state may be used for characterizing whether the encryption operation instruction has been successfully executed or whether the encryption computing of the encryption operation instruction is successful. If the current encryption operation fails, the encryption operation can again be executed, or information may be fed back to a main controller, and then the chip security module operates based on the instruction of the main controller.

In particular embodiments, the execution process of the encryption operation instruction can be monitored, and whether the execution process matches the corresponding security sequence may be determined. If it is determined that the execution process of the current encryption operation instruction matches the corresponding security sequence, the execution result can be outputted based on the encryption operation instruction. If it is determined that the execution process of the current encryption operation instruction does not match the corresponding security sequence, a corresponding action may be taken according to practical application requirements. The security sequence can be used for characterizing a preset execution process of the corresponding encryption operation instruction. In this way, particular embodiments may improve chip security. Since the monitoring is in the software level, different security sequences can be configured for different application requirements, accordingly reducing the associated design costs of the chip.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A chip security module, comprising:
a) an encryption unit configured to execute an encryption operation instruction, monitor execution process of the encryption operation instruction, and determine whether the execution process of the encryption operation instruction matches a corresponding security sequence;
b) wherein in response to determining that the execution process of the encryption operation instruction matches the corresponding security sequence, the chip security module controls an execution result being outputted based on the encryption operation instruction;
c) wherein in response to determining that the execution process of the encryption operation instruction does not match the corresponding security sequence, a corresponding action is taken according to application requirements; and
d) wherein the security sequence is used for characterizing a preset execution process of the corresponding encryption operation instruction.

2. The chip security module of claim 1, wherein the encryption unit receives and executes a plurality of sub-instructions extracted from the encryption operation instruction, monitors an execution sequence of the plurality of sub-instructions, and determines whether the execution sequence matches the corresponding security sequence.

3. The chip security module of claim 2, wherein the security sequence is determined according to the plurality of sub-instructions extracted from the encryption operation instruction, and the security sequence is stored in the chip security module in advance.

4. The chip security module of claim 1, wherein the encryption unit receives and executes a plurality of tag commands extracted from the encryption operation instruction, monitors an execution sequence of the plurality of tag commands, and determines whether the execution sequence matches the corresponding security sequence.

5. The chip security module of claim 4, wherein:
a) the security sequence is determined according to the plurality of tag commands
extracted from the encryption operation instruction, and the security sequence is stored in the chip security module in advance; and
b) the tag commands comprise at least one of an input parameter address, an output parameter address, and a base instruction for achieving the encryption operation instruction.

6. The chip security module of claim 4, wherein the security sequence is determined according to at least two of the plurality of tag commands.

7. The chip security module of claim 1, further comprising a memory configured to store at least one group of the security sequence, a secret key, and/or a private key.

8. The chip security module of claim 1, wherein a corresponding action which is taken according to application requirements comprises one or more of: controlling that not outputting the execution result based on the encryption operation instruction, erasing the secret key and/or the private key stored in the chip security module, destroying a memory in the chip security module, halting a chip, and restarting the chip.

9. The chip security module of claim 1, further comprises a software code unit and a register, wherein:
a) the software code unit is configured to extract a plurality of tag commands from the encryption operation instruction, and to transmit the plurality of tag commands to the encryption unit through the register; and
b) the encryption unit is configured to execute an encryption operation according to the plurality of tag commands.

10. The chip security module of claim 1, wherein the security sequence comprises a sequence header, sequence data, and an ending indicator, the sequence header is used for identifying the encryption operation instruction corresponding to the security sequence, and the sequence data is formed by tag commands extracted from the corresponding encryption operation instruction.

11. The chip security module of claim 10, being further configured to access sequence headers of security sequences according to the current encryption operation instruction, and acquire the security sequence corresponding to the current encryption operation instruction.

12. The chip security module of claim 9, wherein the encryption unit comprises a processor and a buffer, wherein the processor is configured to acquire the plurality of tag commands from the register, successively execute the plurality of tag commands, and to selectively store output parameters of the plurality of tag commands into the buffer.

13. The chip security module of claim 12, wherein the encryption unit further comprises a hardware monitor configured to monitor an operation state of the processor or the register, and to acquire a tag command sequence formed by the plurality of tag commands corresponding to the encryption operation instruction executed by the processor to determine whether the tag command sequence matches the corresponding security sequence.

14. A method of security encryption applied in a chip security module, the method comprising:
a) executing an encryption operation instruction, monitoring execution process of the encryption operation instruction, and determining whether the execution process of the encryption operation instruction matches a corresponding security sequence;
b) in response to determining that the execution process of the encryption operation instruction matches the corresponding security sequence, controlling an execution result being outputted based on the encryption operation instruction;
c) in response to determining that the execution process of the encryption operation instruction does not match the corresponding security sequence, taking a corresponding action according to application requirements; and
d) wherein the security sequence is used for characterizing a preset execution process of the corresponding encryption operation instruction.

15. The method of claim 14, wherein the executing an encryption operation instruction, monitoring execution process of the encryption operation instruction, and determining whether the execution process of the encryption operation instruction matches a corresponding security sequence comprises receiving and executing a plurality of sub-instructions extracted from the encryption operation instruction, monitoring an execution sequence of the plurality of sub-instructions, and determining whether the execution sequence matches the corresponding security sequence.

16. The method of claim 15, wherein the security sequence is determined according to the plurality of sub-instructions extracted from the encryption operation instruction, and the security sequence is stored in the chip security module in advance.

17. The method of claim 14, wherein the executing an encryption operation instruction, monitoring execution process of the encryption operation instruction, and determining whether the execution process of the encryption operation instruction matches a corresponding security sequence comprises receiving and executing a plurality of tag commands extracted from the encryption operation instruction, monitoring an execution sequence of the plurality of tag commands, and determining whether the execution sequence matches the corresponding security sequence.

18. The method of claim 17, wherein:
a) the security sequence is determined according to the plurality of tag commands extracted from the encryption operation instruction, and the security sequence is stored in the chip security module in advance; and
b) the tag commands comprise at least one of an input parameter address, an output parameter address, and a base instruction for achieving the encryption operation instruction.

19. The method of claim 14, wherein the security sequence comprises a sequence header, sequence data, and an ending indicator, the sequence header is used for identifying the encryption operation instruction corresponding to the security sequence, and the sequence data is formed by tag commands extracted from the corresponding encryption operation instruction.

20. The method of claim 19, further comprising:
a) acquiring a tag command sequence formed by a plurality of tag commands corresponding to the encryption operation instruction;
b) accessing the sequence header of at least one security sequence according to the encryption operation instruction, and acquiring the security sequence corresponding to the encryption operation instruction; and
c) determining whether the tag command sequence matches the security sequence corresponding to the encryption operation instruc19tion.
